(19) United States
(12) Patent Application Publication
(10) Pub. No.: US 2007/0089448 A1
(43) Pub. Date: Apr. 26, 2007

(54) Portable misting system

(75) Inventor: Roland Critchfield, Murray, UT (US)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Portable Misting Systems, LLC

(21) Appl. No.: 11/255,003

(22) Filed: Oct. 20, 2005

(51) Int. Cl. F28D 5/00; B60H 1/32

(52) U.S. Cl. 62/304; 62/244

(57) ABSTRACT

A misting system for evaporative cooling or providing a refreshing mist of water that may include a misting nozzle, tubing coupled to the misting nozzle, a flow control valve connected to the tubing, and a pump. The misting system may also include a tank having a body that includes a upper wall, a bottom wall, and a side wall and defines a reservoir chamber for holding liquid to be sprayed out of the misting nozzle. The body includes a refill orifice disposed in the upper wall, a drain orifice positioned remotely from the upper wall, and an outlet orifice connected to the tube, all of which provide access to the reservoir chamber. The misting system may also include a tee joint and a one way coupling valve for connecting the misting system to a fresh water system of a recreational vehicle.

### BACKGROUND OF THE INVENTION

This invention relates generally to misting systems that provide evaporative cooling to an area and provide a refreshing mist of water. More specifically, the invention relates to misting systems that are portable and may be mounted on golf carts, recreational vehicles, and most structures providing shade.

The western portion of the United States has a relatively dry climate generally low relative humidity. This dry climate is ideal for evaporative or “swamp” coolers, which release water into the air to obtain a 10 to 20 degree reduction in air temperature.

Evaporative coolers use considerably less electrical energy than air conditioners and heat pumps, and may be obtained in sizes ranging from the portable to units designed to cool individuals, such as spectators at summer sporting events, to massive, permanently mounted chillers for cooling buildings as large as aircraft hangers. As long as the air remains dry, such coolers can provide effective relief from the hottest days of summer at a fraction of the power requirements of air conditioners and heat pumps.

Evaporative coolers typically employ a fan that is used to blow air through a wet, porous media. In a variation on that principal, the fans are eliminated and nozzles spray water droplets out into the atmosphere, permitting the general air circulation to cool the area surrounding the misting nozzles. These devices have become known as “misters,” and were originally located in commercial areas such as outdoor restaurants and stadium event seating. Less costly pumping units have made “misters” available to homeowners for cooling covered outdoor patio areas.

More recently, personal misters have been provided that consist of a portable water carrier connected to one or more nozzles through flexible tubing. A pump may be provided to pressurize the container and causes water to flow from the tank and out through the nozzle. Since the water is under pressure as it leaves the nozzle, it is converted into a fine spray that is intended to evaporate and cool the air surrounding the user.

In other areas of the United States where the relative humidity is generally high, evaporative cooling is less effective. However, misting systems are still able to provide effective relief from the heat by misting cooler water into the air. The air is cooled as the cooler mist absorbs energy from the air to lower the temperature of the area.

Because misting systems require less electrical power to operate, misting systems may be more portable and less expensive than air conditioners and heat pumps. Consequently, misting systems are being used to enhance the comfort of participants and fans engaged in many outdoor summer activities and sports. For example, misting systems have been attached to golf carts and canopies to provide shade for golfers and fans of bike, motorcycle, and auto racing. Misting systems may also be attached to the canopies of recreational vehicles, which are often parked at and near the sites of sporting events.

However, these currently available misting systems have several shortcomings. For example, the tanks that supply the water to the misting nozzles may be difficult to clean and may contain standing water that is difficult to remove. Thus, the tanks often support flourishing colonies of microorganisms.

Additionally, currently available tanks are not designed to protect an electric pump from running dry while a golf cart or recreational vehicle is positioned on a slope where the water held within the tank may pool remotely from the pump intake. If a pump runs dry, the pump may be damaged. To avoid this problem, currently available tanks attached to golf carts and recreational vehicles may need to be closely monitored to avoid the water level from reaching levels that are sensitive to slopes encountered on golf courses, roads, and parking lots.

Another shortcoming of tanks used with misting systems attached to golf carts and recreational vehicles is that as the golf cart or recreational vehicle starts and stops, the water moving within the tank may impact the sidewalls of the tank with sufficient force to cause structural fatigue and failure of the tank.

A short coming of misting systems used with recreational vehicles is that at each stop of a recreational vehicle, the misting system needs to be set up and taken down. Thus, each time the misting system is set up, the misting system may need to be filled with water and connected to the recreational vehicle to properly position the misting nozzles. Additionally, the pump of the misting system may need to be connected to the electrical power system of the recreational vehicle. Furthermore, currently available misting systems are often attached to structures using threaded fasteners, which may require excessive set up time.

Accordingly, a need exists for a misting system whose tank is designed for easy cleaning and flushing of the reservoir chamber of the tank. Furthermore, a need exists for a tank that may be easily drained and cleaned. A need also exists for a tank that is designed to prevent the electric pump from running dry. Additionally, a need exists for a misting system that may be integrated with the existing fresh water system of a recreational vehicle and that includes. attachment mechanisms that facilitate the attachment and positioning of the misting nozzles and tubing.

### BRIEF SUMMARY OF THE INVENTION

The apparatus of the present invention has been developed in response to the present state of the art, and in particular, in response to the problems and needs in the art that have not been fully solved by currently available misting systems. Thus, the present invention provides misting systems that facilitate the cleaning of the tank, attachment of the misting system to a structure or vehicle, and increases the useful life of the misting system.

In accordance with the invention as embodied and broadly described herein in the preferred embodiments, a misting system is provided. According to one embodiment, the misting system may be installed on a recreational vehicle having an integrated fresh water system. More specifically, the misting system may be connected directly to the fresh water system of the recreational vehicle and may use the pump of the recreational vehicle to pressurize the misting system.

The misting system may include internal components connected to external components by a one way coupling valve. The internal components may be installed within the recreational vehicle and connected to the fresh water system of the recreational vehicle. The external components may be removably connected internal components via the one way coupling valve and to the recreational vehicle to provide cooling to an area outside of the recreational vehicle. Of course, the external components may be used to provide cooling in a passenger compartment of the recreational vehicle.

The internal components may include a tee joint for connecting the misting system to the fresh water system of a recreational vehicle and internal tubing connected to the tee joint. The internal components may also include an accumulator tank and a check valve. The check valve may be positioned along the internal tubing between the accumulator tank and the tee joint to prevent back flow from the accumulator tank to the fresh water system of the recreational vehicle.

The accumulator tank is used to extend the life of the pump of the recreational vehicle. The accumulator tank receives fluid under pressure from the fresh water system for the misting system. Once a certain pressure or fluid level is reached, the accumulator stops receiving fluid from the fresh water system, which provides the pump of the recreational vehicle a chance to cool. The fluid is provided from the accumulator tank to the external components by the pressure of the fluid held in the accumulator tank. Once the pressure or fluid level falls to a predetermined point, pressurized fluid is again received from the fresh water system to provide fluid to the external components of the misting system. A simple mechanical water level sensor, such as that found within a toilet, or pressure sensor may be used to control the pressure or water level within the accumulator tank.

The internal tubing may extend proximate to an outer wall of the recreational vehicle where the one way coupling valve may be located to provide convenient access for connecting the external components of the misting system to the internal components. The one way coupling valve may be disposed within a housing shaped to be mounted generally flush with an exterior surface of the recreational vehicle. The external components and the one way coupling valve may include quick connect couplings to facilitate access, assembly, and disassembly of the external components with the one way coupling valve and the internal components. The one way coupling valve connects the internal tubing to the external tubing and prevents fluid from exiting the internal components until the external components are connected to the internal components.

The external components include one or more misting nozzles and external tubing coupled to the misting nozzle. The external components may also include a flow control valve connected to the external tubing. The flow control valve permits a user of the misting system to determine the flow rate of fluid exiting the one or more misting nozzles. Where a plurality of misting nozzles are included, the misting nozzles may be connected to the external tubing serially, in parallel, or in a combination of linear and parallel connections from the external tubing.

The external components may also include an attachment structure for connecting the misting nozzle to a structure and disposing the misting nozzle to spray mist into an area. For example, the attachment structure may include a magnet for quick attachment to the exterior of a recreational vehicle or spring loaded mounting clips. Alternatively, the attachment structure may include hook and loop fasteners. The attachment structure may also include adhesives for more permanent attachment and positioning of the misting nozzles to a structure such as the recreational vehicle or a canopy attached to or set up near the recreational vehicle.

Additionally, the external components and the one way coupling valve may be connected together by quick connect couplings. For example, the misting nozzles may be connected to the external tubing by quick connect couplings that facilitate the setup and takedown of the misting system.

In another embodiment of the misting system of the invention, the misting system may be attached to a golf cart and may include a misting nozzle, tubing coupled to the misting nozzle, and an attachment structure for connecting the misting nozzle to the golf cart and disposing the misting nozzle to spray mist into an area. The misting system may also include a tank having a reservoir chamber connected to the misting nozzle and a pump disposed to pump fluid from the reservoir chamber into the tubing.

The tank includes a body having an upper wall, a bottom wall, and a side wall that cooperate to define the reservoir chamber. The body may also have a refill orifice disposed in the upper wall providing access to the reservoir chamber. The refill orifice may have a diameter greater than or equal to about 2.5 inches in order facilitate the insertion of ice cubes from an ice maker or ice cube tray into the reservoir chamber. Preferably, the refill orifice may have an orifice having a diameter of about 4 inches. Additionally, the refill orifice may have a large diameter of four or five inches to facilitate the manual cleaning of the reservoir chamber.

In addition to the refill orifice, the tank may include a quick connect refill coupling for connecting a hose to the tank for refilling or flushing the tank with clean water. The quick connect coupling may be mounted to the upper wall.

The body may also have a drain orifice positioned remotely from the upper wall providing access to the reservoir chamber. A drain valve may be attached to the drain orifice or plug may be inserted or threaded onto the drain orifice. By including a drain orifice, old fluid may be flushed from the tank to prevent the growth of microorganisms and facilitate cleaning of the reservoir chamber. For example, a cleaning fluid may be introduced into the reservoir chamber through the refill orifice and flushed from the reservoir chamber through the drain orifice.

The body may have an outlet orifice connected to the tubing providing access to the reservoir chamber. The tubing may extend from a pump disposed within the reservoir chamber through the outlet orifice to the misting nozzle. Alternatively, the outlet orifice may include a quick connect fitting to provide for the attachment of the tubing to the tank.

The pump may be a submersible water pump that is disposed within the reservoir chamber. Alternatively, the pump may be an air pump that pressurizes the tank or a pump that pressurizes water in the tubing. Additionally, the pump may be electrically operated. The pump may also include a filter to prevent solid particles of mineral deposits, dirt, or other material from clogging the tubing and misting nozzles of the misting system.

Where the pump is electrically operated, the pump may be connected to the battery of the golf cart or a recreational vehicle to obtain electrical power. Furthermore, an electrical switch may be connected to the pump for controlling the pump. The electrical switch may be attached to the tank for convenience. In some configurations, the tank may include an arm extending from the body of the tank that positions an end of the arm remotely from the body. When the misting system is attached to a golf cart, the arm may extend between the driver and passenger of a standard two person golf cart to conveniently position an electrical switch attached to the arm proximate the end of the arm.

The tank may also include a plurality of spaced ridges in the bottom wall that are positioned to minimize the sloshing of fluid stored within the reservoir chamber. In other configurations, the tank may include baffles to further minimize the sloshing of fluid stored within the reservoir chamber. By minimizing the sloshing of fluid stored within the reservoir chamber, the effective life of the tank may be extended.

To mount the tank on the golf cart, the tank may include mounting tabs having a hole for receipt of a mechanical fastener such as a bolt. The tank may also include straps or arms for attaching the tank to the wire basket of the golf cart. The straps may include hook and loop fasteners or a buckle-type mechanical fastener.

In some configurations, the tank has a top portion separable from a bottom portion, the top portion includes the upper wall and the bottom portion includes the bottom wall and at least a portion of the side wall. By making the top portion separable from the bottom portion, the reservoir chamber may be scrubbed to completely remove deposits, dirt, and microorganisms from the walls of the reservoir chamber that may form over time.

In some configurations, the interior surface of the bottom wall of the tank may include a bottom-most portion and an angled portion. The angled portion extends from the bottom-most portion at an angle to the bottom-most portion ranging from greater than zero degrees to about thirty degrees or at an angle to the bottom-most portion ranging from about five degrees to about ten degrees. The angled portion encourages water to pool around the bottom-most portion of the bottom wall when the golf cart is parked or moving on an inclined surface where the intake of a submersible pump may be located. The angled portions also help to prevent the pump from prematurely running dry. Furthermore, the angled portion ensures that a greater percentage of the water held within the tank may be used by the pump. Additionally, the drain orifice may be located near the bottom-most portion to facilitate draining the reservoir chamber of fluid.

The tank may be made of plastic, metal, composite, or other materials known in the art. The tank may be manufactured by rotational molding, injection molding, blow molding, machining, or other processes known in the art.

These and other features and advantages of the present invention will become more fully apparent from the following description and appended claims, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exploded perspective view of a misting system according to the invention;

FIG. 2 is a perspective view of a misting system attached to a recreational vehicle;

FIG. 2a is a cross sectional view of attachment structure shown in FIG. 2;

FIG. 2b is a cross sectional view of another attachment structure shown in FIG. 2;

FIG. 2c is a cross sectional view of yet another attachment structure shown in FIG. 2;

FIG. 2d is a cross sectional view of an additional attachment structure shown in FIG. 2;

FIG. 2e is an exploded cross sectional view of the one way coupling valve and an end of the external tubing;

FIG. 3 is a rear elevation view of a misting system attached to a golf cart;

FIG. 4 is a break away perspective view of the misting system of FIG. 3 shown in isolation;

FIG. 5 is a perspective view of a tank according to the invention for use with a misting system;

FIG. 6 is a cross sectional view of the tank of FIG. 5; and

FIG. 7 is an exploded perspective view of another tank according to the invention for use with a misting system.

### DETAILED DESCRIPTION OF THE INVENTION

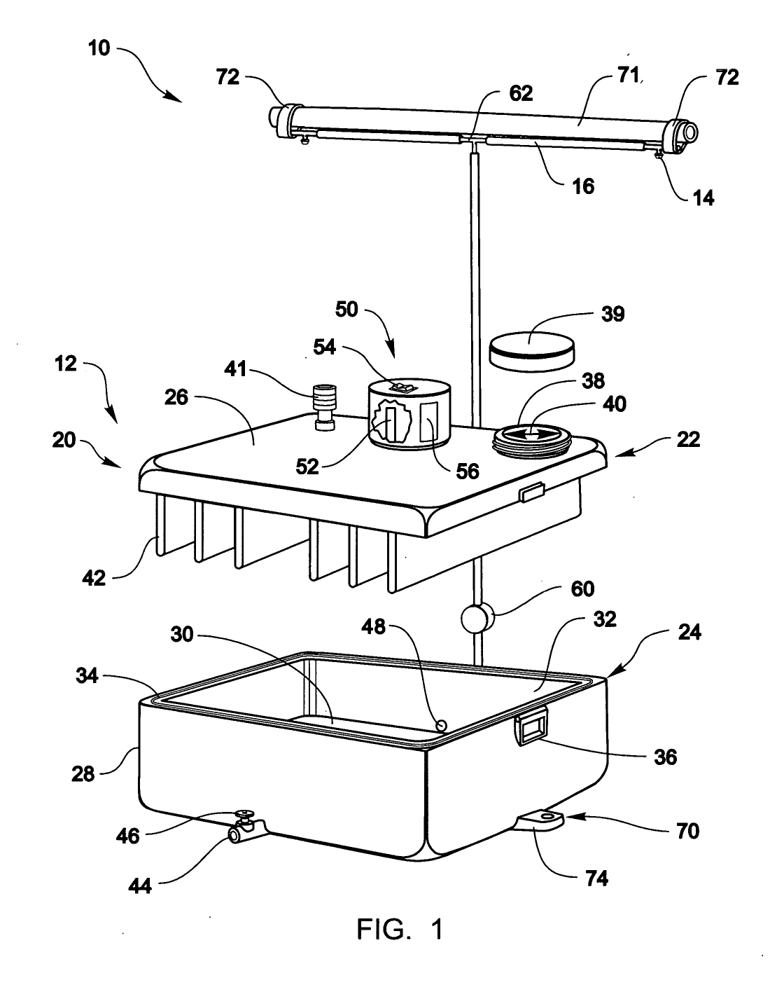

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the misting system of the present invention, as represented in FIGS. 1 through 7, is not intended to limit the scope of the invention, as claimed, but is merely representative of presently preferred embodiments of the invention.

For this application, the phrases “connected to,” “coupled to,” and “in communication with” refer to any form of interaction between two or more entities, including mechanical, electrical, magnetic, electromagnetic, and thermal interaction. The phrase “attached to” refers to a form of mechanical coupling that restricts relative translation or rotation between the attached objects.

The phrase “attached directly to” refers to a form of attachment by which the attached items are either in direct contact, or are only separated by a single fastener, adhesive, or other attachment mechanism. The term “abutting” refers to items that are in direct physical contact with each other, although the items may not be attached together. The terms “integrally formed” refer to a body that is manufactured integrally, i.e., as a single piece, without requiring the assembly of multiple pieces. Multiple parts may be integrally formed with each other if they are formed from a single work piece.

FIG. 1 is an exploded perspective view of a misting system 10 according to the invention. The misting system 10 may be used to cool a variety of areas and may be attached to a variety of structures, such as recreational vehicles, golf carts, canopies, gazebos, porches, and patios. The misting system 10 may include a source of fluid 12 for use with the misting system 10, one or more misting nozzles 14, and tubing 16 for delivering water from the source of fluid 12 to the misting nozzles 14. The tubing 16 may include multiple sections to accommodate different components and configurations of the misting system.

As shown, the source of fluid 12 is a tank 20 that may include a top portion 22 attachable to a bottom portion 24. Specifically, the top portion 22 has the upper wall 26 that attaches to a side wall 28 of the bottom portion 24. The sidewall 28 extends from a bottom wall 30 of the bottom portion 24. Together, the upper wall 26, the side wall 28, and the bottom wall 30 cooperate to define a reservoir chamber 32 in which fluid, such as water may be held for subsequent delivery to the misting nozzles 14. As shown, the tank 20 may also include a gasket 34 for preventing leaks between the top portion 22 and the bottom portion 24.

The top portion 22 is separable from the bottom portion 24 in order to facilitate the cleaning of the reservoir chamber 32. To attach the top portion 22 to the bottom portion 24, the tank 20 may also include mechanical fasteners 36, such as a latch, clip, screw, etc.

The upper wall 26 of the top portion 22 may include a refill orifice 38 to provide convenient access to the reservoir chamber 32. The refill orifice 38 may be covered by a cap 39. The refill orifice 38 may be sized to facilitate the insertion of ice cubes into the reservoir chamber 32 through the refill orifice 38. Consequently, the refill orifice 38 may have a diameter 40 greater than or equal to about 2.5 inches. In some configurations, the refill orifice 38 may have a diameter 40 greater than or equal to about 4 inches.

In addition to the refill orifice 38, the tank 20 may also include a quick connect coupling 41. The quick connect coupling 41 permits the tank 20 to be connected to a hose and water supply (not shown) which facilitates cleaning and refilling of the tank 20 with fresh water.

The tank 20 may also include baffles 42 to reduce the sloshing of liquid held in the reservoir chamber 32. As shown, the baffles 42 may extend from the upper wall 26 toward the bottom wall 30. Alternatively, the baffles 42 may extend from the bottom wall 30 or side wall 28.

By including baffles 42 in the tank 20, a liquid stored within the tank 20 is unable to move directly from one side of the tank to the other to impact on the sidewall 28 as the tank 20 is being moved. Thus, the impact energy of the liquid on the sidewall 28 is minimized, which helps to prevent fatigue and failure of the tank 20. By minimizing the impact energy of the liquid on the sidewall 28, the noise caused sloshing of liquid is also reduced which can also be a distraction if the tank 20 is positioned near activities that require the full attention of participants, such as golfers on a golf course.

The tank 20 may include a drain orifice 44, a drain valve 46, and an outlet orifice 48. The drain orifice 44 is positioned remotely from the upper wall 26 and may be positioned in or adjacent to the bottom wall 30 to facilitate flushing liquid from the tank 20. The drain valve 46 may be used to control the flow of liquid from the reservoir chamber 32 through the drain orifice 44.

The outlet orifice 48 connects the reservoir chamber 32 to the tubing 16. As shown, the outlet orifice 48 may be disposed in the sidewall 28 near the bottom wall 30. Of course, the outlet orifice 48 may be positioned in the upper wall 26 or the bottom wall 30 depending on the configuration of the tank 20.

In addition to the tank 20, the misting system 10 may include a pump 50 for moving fluid from the tank 20 to the misting nozzles 14. In this configuration, the pump 50 is an air pump 50 that pressurizes the reservoir chamber 32 of the tank 20. The pressure in the tank 20 pushes liquid out of the outlet orifice 48 into the tubing 16 to the misting nozzles 14. Of course, the pump 50 may be a water pump or other type of pump known in the art.

The pump 50 may be directly attached to the tank 20 and may include a pressure sensor 52, a switch 54 for controlling the pump 50, and a power source 56, such as a battery or a solar cell. The pressure sensor 52 may be used to control the pump 50 to maintain the reservoir chamber 32 within a desired pressure range. The switch 54 may be used to turn the pump 50 on and off and may also be used to control the pumping rate of the pump 50. The power source 56 may be used to power the pump 50 permitting the misting system 10 to be portable and independent of a fixed source of power.

The misting system 10 may include a flow control valve 60 and a flow splitting joint 62. The flow control valve 60 may be used to control the flow of fluid through the tubing 16 to the misting nozzles 14. The flow splitting joint 62 permits fluid to be delivered to misting nozzles 14 arranged in parallel.

The misting system 10 may also include mounting structures 70 for attaching the tank 20 to a structure 71, such as a vehicle or building if desired by a user and attachment structures 72 for attaching the tubing 16 and misting nozzles 14 to the structure 71. As shown, the mounting structure 70 may be a mounting tab 74 that permits the tank 20 to be bolted to the structure 71. The attachment structures 72 may be straps wrapped around the tubing 16 and misting nozzles 14.

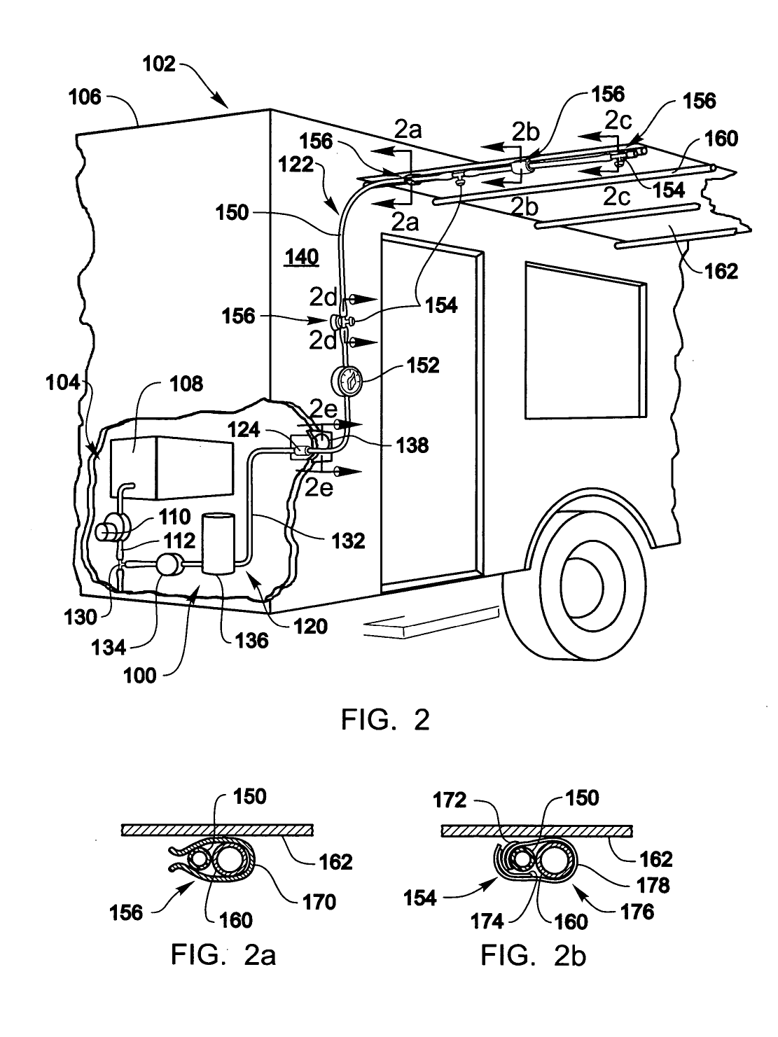

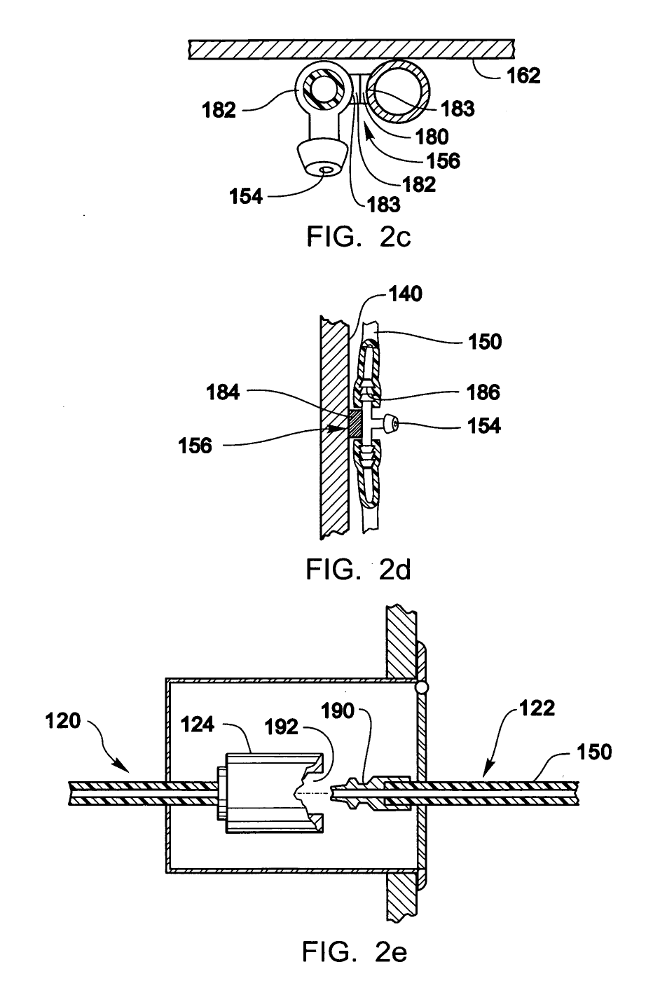

FIG. 2 is a perspective view of a misting system 100 attached to a recreational vehicle 102. More specifically, the misting system 100 attached to the freshwater system 104 of the recreational vehicle 102 housed within the frame 106 of the recreational vehicle 102. The fresh water system 104 of a recreational vehicle 102 includes a source of fresh water 108, such as a tank, and a pump 110 for distributing fresh water throughout the fresh water system 104. A conduit 112 extends from the source of fresh water 108 and the pump 110 that delivers fresh water to the rest of the fresh water system 104 that may include faucets, toilets, showers, swamp coolers, etc. (not shown).

The misting system 100 includes internal components 120, external components 122, and a one way coupling valve 124 that permits the external components 122 to be efficiently connected to the internal components 120.

The internal components 120 of the misting system 100 are disposed within the frame 106 of the recreational vehicle 102 and are connected to the fresh water system 104 by a tee joint 130. To connect the tee joint 130 to the fresh water system 104, the conduit 112 of the fresh water system 104 may be cut and the tee joint 130 attached between the cut ends of the conduit 112.

The internal components 120 may also include internal tubing 132 coupled to the tee joint 130 and the one way coupling valve 124, a check valve 134, and an accumulator 136. The internal tubing 132 may be cut into sections to connect the check valve 134 and the accumulator 136 to the tee joint 130 and the one way coupling valve 124.

The check valve 134 permits pressurized fresh water to only flow from the fresh water system 104 to the accumulator 136 or to the one way coupling valve 124. Additionally, the check valve 134 permits the fresh water held within the accumulator 136 to be held at a lower pressure than the fresh water system 104. In some configurations, the check valve 134 and the accumulator 136 may be integrated into a single structure.

The accumulator 136 stores pressurized fresh water for distribution to the external components 122. The accumulator 136 extends the life of pump 110 of the recreational vehicle 102 by only intermittingly taking water from the fresh water system 104, which allows the pump 110 to be intermittently used instead of having to continuously provide pressurized fresh water to the misting system 100.

The one way coupling valve 124 may be disposed within a housing 138 shaped to be mounted generally flush with the exterior surface 140 of the recreational vehicle 102. The housing 138 permits convenient external access to the one way coupling valve 124 while protecting the one way coupling valve 124 from damage, dirt, and insects. The one way coupling valve 124 permits the flow of fresh water in one direction when the one way coupling valve 124 is connected to the external components 122. The one way coupling valve 124 prevents water from being wasted when the misting system 100 is not in use.

The external components 122 may include external tubing 150, a flow control valve 152 connected to the external tubing 150, and misting nozzles 154. The external tubing 150 distributes pressurized fresh water from the internal components 120 of the misting system 100 to the flow control valve 152 and the misting nozzles 154. The external tubing 150 may be cut into segments for coupling to the flow control valve 152 and the misting nozzles 154.

The flow control valve 152 permits a user to control the flow of fresh water to the misting nozzles 154 and may permit a user to stop the flow of water to the misting nozzles 154. The misting nozzles 154 spray fresh water in a fine mist that facilitates evaporative cooling of an area.

The external components 122 may also include a variety of attachment structures 156 for connecting one of the misting nozzles 154 or the external tubing 150 to a structure, such as the frame 160 of the canopy 162 or the exterior surface 140 of the recreational vehicle 102. The attachment structures 156 may be used to dispose the misting nozzles 154 to spray mist into an area.

FIG. 2a is a cross sectional view of one of the attachment structures 156 shown in FIG. 2. As shown, the attachment structure 156 is a clip 170 used to attach the external tubing 150 to the frame 160 of the canopy 162. The clip 170 may be made of plastic or metal and may be manufactured by stamping, injection molding, extrusion, machining, and other manufacturing methods known in the art.

FIG. 2b is a cross sectional view of another attachment structure 156 shown in FIG. 2. The attachment structure 156 comprises a piece of fabric of small hooks 172 and a fabric of small loops 174 and are generally referred to as a hook and loop fastener 176. This type of fastener 176 facilitates attachment and detachment of the external components 122 to a structure. The hooks 172 and loops 174 may be combined on a single strap of fabric 178 that may be wrapped around the frame 160 and the external tubing 150.

Alternatively to the attachment structure 156 shown in FIG. 2b, FIG. 2c shows one piece of fabric 180 comprising either hooks or loops attached to the frame 160 and another piece of fabric 182 comprising the other of the hooks or loops attached to a misting nozzle 154. This configuration permits the external component 122 to be attached by simply pressing it against the frame 160. The pieces of fabric 180, 182 may be attached by a mechanical fastener (not shown) or an adhesive 183.

FIG. 2d is a cross sectional view of an additional attachment structure 156 used to directly attach a misting nozzle 154 to the exterior surface 140 of the recreational vehicle 102. The attachment structure 156 is a magnet 184 which permits the misting nozzle 154 to be attached to the steel of the exterior surface 140 of the recreational vehicle 102 by abutting the magnet 184 to the exterior surface 140 of the recreational vehicle 102.

As shown, the misting nozzle 154 may be attached to the external tubing 150 using a barbed connection 186. The barbed connection 186 provides a relatively simple and efficient means of coupling the misting nozzle 154 to the external tubing 150.

FIG. 2e is an exploded cross sectional view of the one way coupling valve 124 and an end of the external tubing 150. As shown, the end of the external tubing 150 includes a male quick connect coupling 190 for coupling with the female quick connect coupling 192 of the one way coupling valve 124. The use of the quick connect couplings 190, 192 facilitates the attachment and detachment of the external components 122 to the internal components 120 to extend the life of the misting system 100.

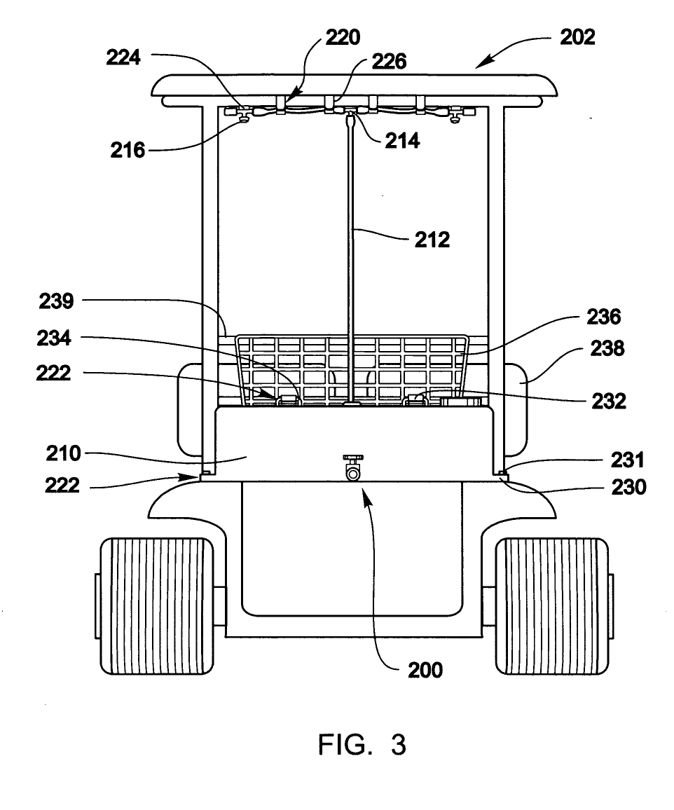

FIG. 3 is a rear elevation view of a misting system 200 attached to a golf cart 202. As shown, the misting system 200 may include a tank 210, tubing 212, a tee joint 214, and misting nozzles 216. The misting nozzles 216 are in fluid communication with the tank 210 through the tube 212 and tee joint 214. The tee joint 214 permits the misting nozzles 216 to be supplied with fluid from the tank 210 in parallel and is disposed between sections of the tube 212 coupled to the tank 210 and the misting nozzles 216.

For attachment to the golf cart 202, the misting system 200 may also include attachment structures 220 for securing the misting nozzles 216, the tube 212, and the tee joint 214 to the golf cart 202 and mounting structures 222 for securing the tank 210. As shown, the attachment structures 220 in this configuration may include adhesive strips 224 attached to the misting nozzles 216 and hook and loop fastener straps 226.

The mounting structures 222 may include mounting tabs 230, bolts 231, and straps 232 that are connected to the tank 210 by loops 234. The mounting tabs 230 permit the tank 210 to be bolted 231 directly to the golf cart 202 and positioned under the wire basket 236 and behind the seats 238 of the golf cart 202. The straps 234 may be wrapped around a portion of the wire basket 236 or to the frame 239 supporting the wire basket 236 of the golf cart 202.

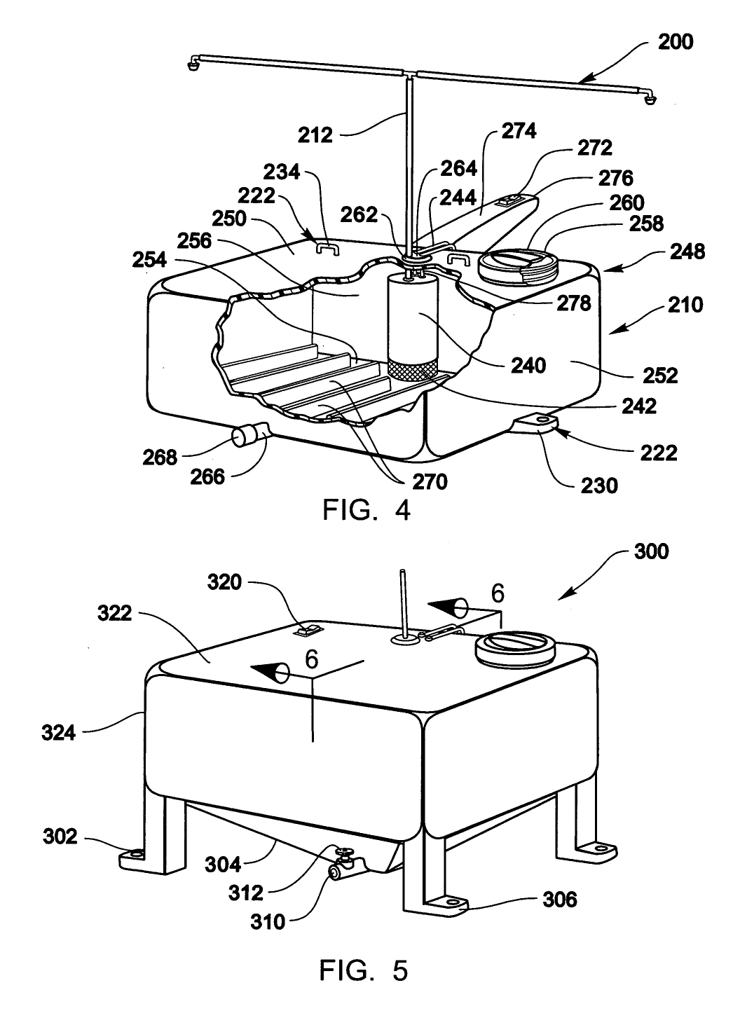

FIG. 4 is a break away perspective view of the misting system 200 of FIG. 3 shown in isolation. As shown, the misting system 200 may include a pump 240 positioned within the tank 210. In this configuration, the pump 240 may be a water pump that draws water from the tank 210 and directly pumps the water into tubing 212. Specifically, the pump 240 may be a diaphragm pump. Thus, the pump 240 pressurizes the water in the tubing 212. The pump 240 may include a screen 242 to prevent debris in the tank 210 from being sucked into the pump 240. The pump 240 may also include electrical wiring 244 that permits the pump 240 to be electrically connected to and powered by the battery (not shown) of the golf cart.

The tank 210 may be integrally formed as a body 248 that may include an upper wall 250, a sidewall 252, and a bottom wall 254 that cooperate to define a reservoir chamber 256 for storing water for use with the misting system 200. The upper wall 250 may include a refill orifice 258 to facilitate the filling, flushing, and cleaning of the reservoir chamber 256, a cap 260 for covering the refill orifice 258, and an outlet orifice 262 for providing access to the reservoir chamber 256.

As shown, the tubing 212 may extend through the outlet orifice 262 to connect to the pump 240. The electrical wiring 244 also extends through the outlet orifice 262 to connect to the battery (not shown) of the golf cart.

The outlet orifice 262 may include a seal cap 264 that extends around the tubing 212 and electrical wiring 244 to prevent liquid from leaking out of the outlet orifice 262. The seal cap 264 may be a foamed elastomeric material that is cut to permit it to extend around the tubing 212 and seal against the sides of the outlet orifice 262. Alternatively, the seal cap 264 may be melted plastic that is disposed in the outlet orifice 262 and allowed to solidify around the tubing 212 and electrical wiring 244.

The tank 210 may also include a drain orifice 266 positioned remotely from the upper wall 250 to provide convenient drainage of fluid from the reservoir chamber 256. The drain orifice 266 may be closed by a cap 268.

Internally, the tank 210 may include a plurality of ridges 270 positioned in the bottom wall to help minimize the sloshing of fluid stored within the reservoir chamber 256 against the sidewall 252.

Additionally, the tank 210 may include an electrical switch 272 for controlling the pump 240 and an arm 274 extending from the body 248 of the tank 210. The arm 274 includes an end 276 that is positioned remotely from the body 248 of the tank 210. The electrical switch 272 may be attached proximate to the end 276 of the arm 274. The arm 274 helps to position the electrical switch 272 between the driver and passenger of the golf cart for convenient control of the misting system 200.

The electrical switch 272 may be molded into the plastic of the tank 210. The wires 278 for connecting the electrical switch 272 to the pump 240 may be molded in the plastic of the arm 274 and the body 248 of the tank 210.

For mounting the tank 210 to the golf cart 202, the tank 210 includes the mounting structures 222, such as the mounting tabs 230 and the loops 234. The mounting tabs 230 and the loops 234 may be integrally formed with the body 248 of the tank 210 or may be made separately that are attached to the body 248 of the tank 210. To attach the mounting tabs 230 and the loops 234 to the body 248, they may be molded directly into the plastic of the body 248 as inserts or they may be attached by an adhesive or mechanical fastener (not shown). Of course, the tank 210 may be made of plastic, metal, ceramic, composite and may be made by molding, machining, and other forming methods known in the art.

FIG. 5 is a perspective view of a tank 300 according to the invention for use with a misting system 200. The tank 300 is similar to the tank 200 shown in FIGS. 3 and 4 and may include support legs 302. As shown, the bottom wall 304 of the tank 200 may be sloped and the support legs 302 help stabilize and support the tank 300. The support legs 302 may include mounting attachments 306 for securing the tank 300 to a golf cart (not shown).

The tank 300 may also include a drain orifice 310 and a drain valve 312 that is positioned near the bottom most part of the bottom wall 304. This position of the drain orifice 310 facilitates the draining and flushing of the tank 300.

The tank 300 may also include an electrical switch 320 that is disposed in the upper wall 322 of the tank 300 near the sidewall 324. This position permits a driver of the golf cart (not shown) to control the misting system 200 of FIG. 3 during the entry and exit of the golf cart.

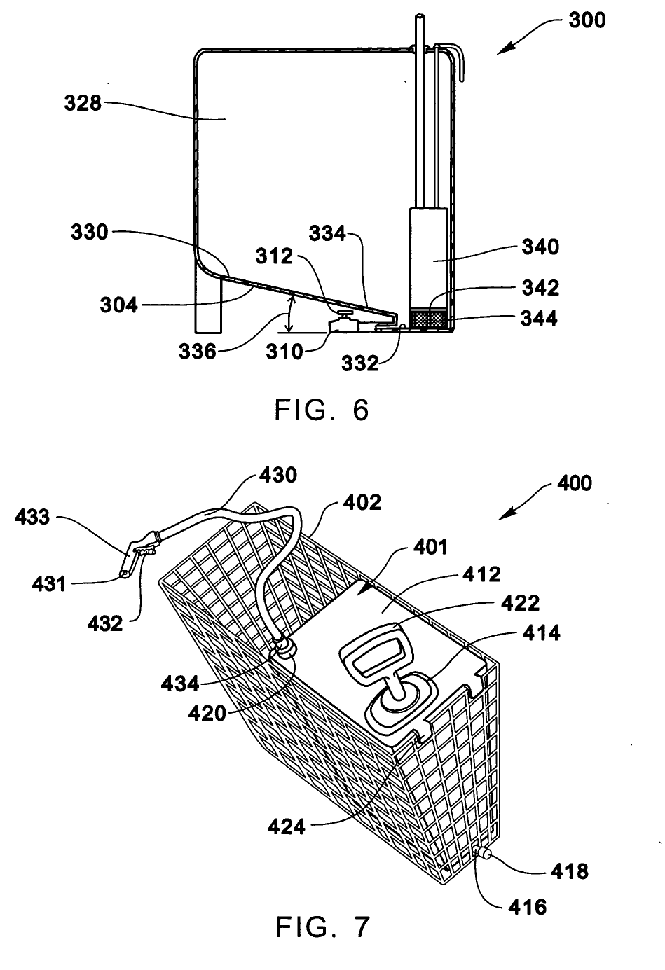

FIG. 6 is a cross sectional view of the tank 300 of FIG. 5 along line 6-6. As shown, the tank 300 includes a reservoir chamber 328 partly defined by the bottom wall 304 having an interior surface 330. The interior surface 330 of the bottom wall 304 has a bottom-most portion 332 and an angled portion 334 that extends from the bottom-most portion 332 at an angle 336 to the bottom-most portion 332 ranging from greater than zero degrees to about twenty degrees. In some configurations, the angle 336 may be greater than twelve degrees or may range from about five degrees to about fifteen degrees. Additionally, the surface area of the angled portion 334 may be greater than or equal to the surface area of the bottom-most portion 332.

A pump 340 may be disposed within the reservoir chamber 328 so that an inlet 342 of the pump 340 is disposed proximate to the bottom-most portion 332. The inlet 342 of the pump may be surrounded by a screen 344 to prevent debris from clogging the pump 340. As shown, the pump 340 may be a submersible pump. By disposing the inlet 342 of the pump 340 proximate the bottom-most portion 332, fluid is retained around the inlet 342 which helps to prevent the pump 340 from running dry.

Additionally, the drain orifice 310 and the drain valve 312 may be positioned near the bottom-most portion 332 of the bottom wall 304. This facilitates cleaning of the tank by allowing chemicals to be flushed and replaced by clean water for use in the misting system 200.

FIG. 7 is a perspective view of another misting system 400 according to the invention. As shown, the misting system 400 includes tank 401 that has a body shaped to be disposed within the basket 402 found on most types of golf carts. Like the tank 200 of FIGS. 3 and 4, the tank 401 includes a body 412, a refill orifice 414, a drain orifice 416, a cap 418, and an outlet orifice 420.

The misting system 400 also includes a hand pump 422 and mounting clips 424. The hand pump 422 increases the portability of the tank 401. The mounting clips 424 permit the tank 401 to be efficiently and quickly secured in the wire basket 402 of the golf cart (not shown). For example, to remove the tank 401 from the basket 402, the tank 400 may be lifted up to disengage the mounting clips 424 and then removed from the basket. The mounting clips 424 may be integrally formed with the body 412 or may be attached to the body by mechanical fasteners, adhesives, or by insert molding the body over a portion of the mounting clip 424.

As shown, the tubing 430 extends from the outlet orifice 420 and is connected to a misting nozzle 431 that is integrated with a flow control valve 432 in a grip housing 433. The tubing 430 may be connected to the outlet orifice 420 by a quick connect coupling 434 to facilitate setup and removal of the tank 401 and misting system 400 from the golf cart (not shown). The grip housing 433 permits a user to control the positioning of the misting nozzle 431. The flow control valve 432 is disposed in the grip housing 433 to provide a user with convenient control the flow of fluid from the tank 401 to the misting nozzle 431. Additionally, the flow control valve 432 may be a burst valve that automatically closes when the flow control valve 432 is released to prevent the wasting of water while a user is away from the misting system 400.

In summary, a portable misting system is presented that may be used to cool a variety of areas and attached to a variety of structures. The various components of the misting systems presented above may be made of plastic, metal, ceramic, or a composite of different materials. Furthermore, the various components of the misting systems presented above may be made by injection molding, rotational molding, blow molding, machining, extrusion, stamping, and other manufacturing processes known in the art.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A misting system comprising:
external components;
a misting nozzle;
an external tube coupled to the misting nozzle;
a flow control valve connected to the external tube;
internal components comprising:
a tee joint for connecting the misting system to the fresh water system of a recreational vehicle;
an internal tube connected to the tee joint; and
a one way coupling valve connected to the internal tube and the external tube.

2. The misting system of claim 1, wherein the internal components further comprise an accumulator tank and a check valve connected to the internal tube.

3. The misting system of claim 1, wherein the one way coupling valve is disposed within a housing shaped to be mounted generally flush with an exterior surface of the recreational vehicle.

4. The misting system of claim 1, wherein the external components and the one way coupling valve are connected by quick connect couplings.

5. The misting system of claim 1, further comprising an attachment structure for connecting the misting nozzle to a structure and disposing the misting nozzle to spray mist into an area.

6. The misting system of claim 5, wherein the attachment structure comprises a magnet.

7. A misting system comprising:
a misting nozzle;
a tube coupled to the misting nozzle;
an attachment structure for connecting the misting nozzle to a structure and disposing the misting nozzle to spray mist into an area;
a tank connected to the misting nozzle, the tank comprising a body having a upper wall, a bottom wall, and a side wall that define a reservoir chamber, wherein the body further comprises a refill orifice disposed in the upper wall providing access to the reservoir chamber, a drain orifice positioned remotely from the upper wall providing access to the reservoir chamber, and an outlet orifice connected to the tube providing access to the reservoir chamber; and
a pump disposed to pump fluid from the reservoir chamber into the tube.

8. The misting system of claim 7, further comprising a flow control valve connected to the tube.

9. The misting system of claim 7, further comprising a drain valve attached to the drain orifice.

10. The misting system of claim 7, further comprising an electrical switch connected to the pump for controlling the pump.

11. The misting system of claim 10, wherein the tank further comprises an arm extending from the body of the tank to dispose an end of the arm remotely from the body, wherein the electrical switch is attached to the arm proximate the end of the arm.

12. The misting system of claim 7, wherein the refill orifice has a diameter greater than or equal to about 2.5 inches.

13. The misting system of claim 7, wherein the pump is a submersible pump and is disposed within the reservoir chamber.

14. The misting system of claim 7, wherein the tank further comprises a plurality of spaced ridges in the bottom wall disposed to minimize sloshing of fluid stored within the reservoir chamber.

15. The misting system of claim 7, wherein the tank further comprises mounting-tabs for securely mounting the tank to a golf cart.

16. The misting system of claim 7, wherein the tank further comprises a top portion and a bottom portion, the top portion comprising the upper wall and the bottom portion comprising the bottom wall, wherein the top portion is separable from the bottom portion to facilitate the cleaning of the reservoir chamber.

17. The misting system of claim 7, wherein the bottom wall of the tank has an interior surface, the interior surface comprising a bottom-most portion and an angled portion, wherein the angled portion extends from the bottom-most portion at an angle to the bottom-most portion.

18. The misting system of claim 17, wherein the angled portion extends from the bottom-most portion at an angle to the bottom-most portion ranging from greater than zero degrees to about thirty degrees.

19. The misting system of claim 18, wherein the angled portion extends from the bottom-most portion at an angle to the bottom-most portion ranging from about five degrees to about fifteen degrees.

20. The misting system of claim 18, wherein the pump and the drain orifice are disposed proximate the bottom-most portion of the interior surface of the bottom wall.

21. A misting system comprising:
a misting nozzle;
a tube coupled to the misting nozzle;
a tank connected to the misting nozzle, the tank comprising a upper wall, a bottom wall, and a side wall that define a reservoir chamber, wherein the tank further comprises a refill orifice disposed in the upper wall, a drain orifice positioned remotely from the upper wall, and an outlet orifice connected to the tube, wherein the bottom wall of the tank has an interior surface comprising a bottom-most portion having a surface area and an angled portion having a surface area, wherein the angled portion extends from the bottom-most portion at an angle to the bottom-most portion, wherein the surface area of the angled portion is greater than or equal to the surface area of the bottom-most portion; and
a pump disposed to pump fluid from the reservoir chamber into the tube.
